(19) United States
(12) Patent Application Publication
(10) Pub. No.: US 2004/0202787 A1
(43) Pub. Date: Oct. 14, 2004

(54) Method and apparatus for applying and removing imageable materials

(75) Inventors: Julian Y. Chia, Richmond (CA); Fernando Lopes, Richmond (CA); Bradley J. F. Palmer, Surrey (CA)

Correspondence Address: OYEN, WIGGS, GREEN & MUTALA, 480 - THE STATION, 601 WEST CORDOVA STREET, VANCOUVER, BC, V6B 1G1, CA

(73) Assignee: Creo Inc., Burnaby (CA)

(21) Appl. No.: 10/376,273

(22) Filed: Mar. 3, 2003

(51) Int. Cl. C23G 1/36

(52) U.S. Cl. 427/256; 118/72; 134/10; 134/21

(57) ABSTRACT

A spray nozzle system is useful for applying imageable materials onto substrates. The system may be used for on-site fabrication of lithographic printing surfaces for use in printing. A wash nozzle and vacuum port are integrated with the spray nozzle for use in cleaning the printing residues from a used printing surface in preparation for a subsequent print job. The integrated nozzle assembly is useful in coating and cleaning operations, performed either on-press or off-press, and enables the reuse of a single printing substrate in a number of print jobs.

### FIELD OF THE INVENTION

This invention relates to applying coatings of materials to surfaces. The invention has particular application in the field of lithographic printing where it can be applied to applying lithographic precursor materials to printing surfaces.

### BACKGROUND OF THE INVENTION

There are many applications in the printing industry which require the application of an imageable material to a substrate. One such application is lithographic printing. Lithographic printing involves imaging a material to produce a surface having regions with different affinities to water and/or ink. The material maybe provided on a sheet-like substrate in the form of a printing plate, on a sleeve or directly on a cylinder in a printing press.

### SUMMARY OF THE INVENTION

One aspect of this invention provides apparatus for preparing and recycling a printing surface. A common chassis holds a spray nozzle for coating a printing substrate with a lithographic precursor material and a wash nozzle for removing printing residues from a printing surface that has been used in a printing operation. The spray and wash nozzles are surrounded by a shroud that also incorporates a vacuum orifice for controlling over spray and for removing printing residues released by the wash nozzle action. Collected residues may be transferred to a treatment system for safe disposal and/or recycling.

Another aspect of the invention provides an apparatus for applying an imageable coating to a substrate. The apparatus comprises at least one spray nozzle directed toward the substrate, the nozzle connectable to a supply of an imageable coating material; and, at least one wash nozzle directed at the substrate the wash nozzle connectable to a source of pressurised wash fluid. The spray nozzle and the wash nozzle form an integrated unit.

Another aspect of the invention provides apparatus for preparing and recycling a printing surface. The apparatus comprises a support chassis; at least one spray nozzle for coating a printing substrate with a lithographic precursor material and for optionally applying a cleaning agent to aid in cleaning printing residues from the printing surface following a printing operation; at least one wash nozzle, supplied with a source of pressurised wash fluid, the wash nozzle directed at the printing surface for removing the printing residues therefrom; a shutter jet disposed to eject a fluid stream across in front of the spray nozzle during a purging or priming operation, the fluid stream operative to contain purging and priming products ejected by the spray nozzle; and, a shroud surrounding the spray nozzle and the wash nozzle and extending towards the printing substrate, the shroud operative in combination with at least one orifice connected to a vacuum source to remove overspray and residues generated in the operation of the spray nozzle and the wash nozzle.

Yet another aspect of the invention provides a spray nozzle apparatus for coating a substrate with an imageable fluid. The apparatus comprises a nozzle body having a plurality of fluid connection ports on a rear side thereof; a spray nozzle tip on a front side of the nozzle body for ejecting the imageable fluid, the spray nozzle tip connected to one of the connection ports via a fluid conduit extending through the nozzle body; and, a conduit surrounding the spray nozzle tip, the conduit connectable via another one of the fluid connection ports to a supply of pressurized atomising fluid.

A further aspect of the invention provides a method for coating a printing substrate with a fluid in an on-site platemaking system. The method comprises providing a source of fluid; ejecting the fluid via a spray nozzle tip; and, atomizing the fluid and directing the atomized fluid towards the printing substrate using a flow of pressurised fluid through an air conduit surrounding the spray nozzle tip.

Another aspect of the invention provides a method for recovering a wash fluid from a wash effluent containing residues from washing a printing surface after use in a printing operation. The method comprises: collecting the wash effluent via one or more orifices, the orifices coupled to a vacuum source; and reusing the wash effluent as wash fluid in a subsequent cleaning operation. In preferred embodiments the method comprises separating the residues from the wash effluent in one or more fluid treatment stages prior to the reuse.

Another aspect of the invention provides a method of removing printing residues from a printing surface following a printing operation. The method comprises: directing two or more jets of a wash fluid at the printing surface to release the printing residues from the printing surface; redirecting the printing residues away from the printing surface; and, collecting the printing residues using a vacuum source.

Further aspects of the invention and features and advantages of various embodiments of the invention are described below.

### BRIEF DESCRIPTION OF THE DRAWINGS

In drawings which illustrate non-limiting embodiments of the invention:

FIG. 1-A is a depiction of one embodiment of the integrated spray nozzle assembly of the present invention;

FIG. 1-B is a depiction of another embodiment of the integrated spray nozzle assembly of the present invention;

FIG. 2 is a flow diagram for a spray and cleaning operation;

FIG. 3 is a detailed view of a spray nozzle;

FIG. 4 is a detailed view of a multiple jet wash nozzle; and,

FIG. 5 shows a filtration system for treating the fluid collected in a wash operation.

### DESCRIPTION OF PREFERRED EMBODIMENTS

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded as being illustrative and not restrictive.

This invention relates to apparatus and methods for applying sprayed coatings to substrates. The invention has particular application in applying lithographic precursor materials to printing surfaces in lithographic printing. The invention maybe applied in other ways including the application of layers of ablatable or otherwise imageable materials to the surfaces of flexographic printing plates, the application of coatings for gravure printing, the application of coatings to glass metal or plastic substrates and the like. The following description describes example applications of the invention in the field of lithographic printing.

The term “curing” is used herein to refer to any process for preparing a coated lithographic precursor material for imaging, including heating, irradiating with a light source, irradiation with ultraviolet light or simply allowing the passage of time. Curing includes drying. The term “lithographic precursor material” is used herein to describe a material that can be sprayed onto a printing substrate and subsequently imagewise converted or removed to create a printing surface that may be selectively inked and used for lithographic printing. Precursor materials may include but are not limited to, powders, fluids, fluid suspensions, mixtures of a plurality of different fluids, or pluralities of fluids that are mixed just prior to spraying. The term “printing substrate” is used herein to describe any surface that is able to receive sprayed lithographic precursor material including but not limited to the surface of a press cylinder, a plate substrate either clamped to a press cylinder or a separate device, or a cylindrical sleeve substrate that can be slid over a press cylinder. The substrate material could be aluminium, steel, polyester or any one of a number of other materials suitable for use in printing plates.

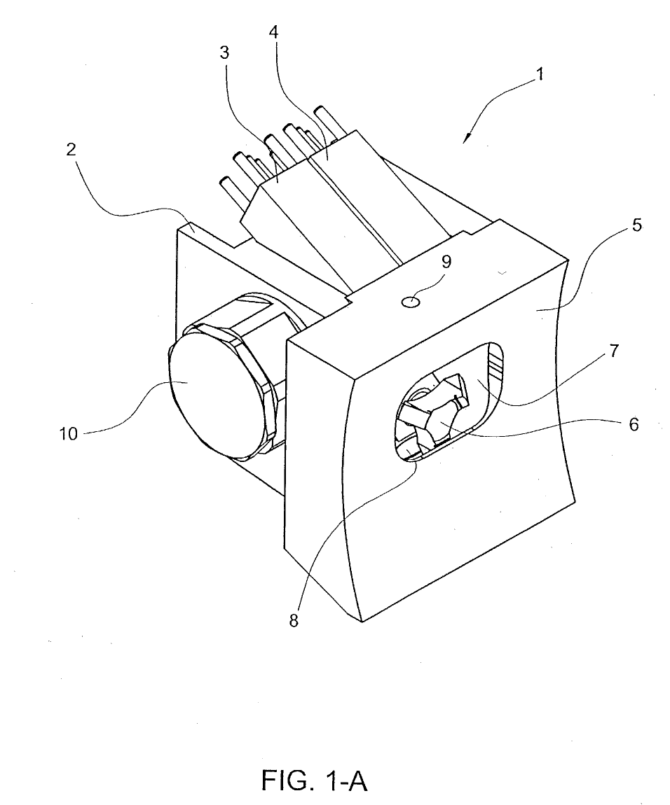

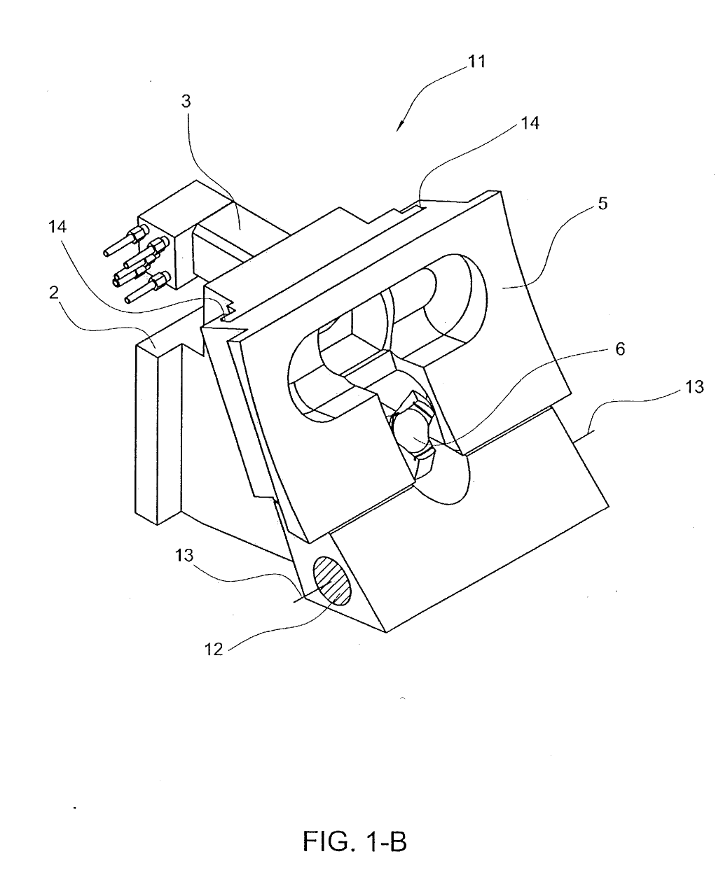

FIG. 1-A shows a spray nozzle assembly 1 according to the invention. Nozzle assembly 1 comprises a mounting chassis 2 that carries at least one spray nozzle 3, an optional additional nozzle 4, a shroud 5, and a wash nozzle 6. Preferably, shroud 5 has a front face formed with a radius substantially the same as that of a printing cylinder with which nozzle assembly 1 will be used. Shroud 5 can be brought close to the cylinder surface during spray or wash operations to contain spray and wash fluids.

Between shroud 5 and chassis 2 is an open space or chamber 7. A vacuum port 8 is incorporated into the chassis and attached to a vacuum source (not shown) to establish a flow through the chamber 7 towards vacuum port 8. Chassis 2 is attached to a manifold (not shown) that carries supply lines for the lithographic precursor material, cleaning solutions, air supply, and vacuum. Preferably, all fluid and air connections are made by quick-connect type fittings, incorporating sealing and shut off devices to enable a quick, clean, change of nozzle assembly 1.

FIG. 1-B shows a spray nozzle assembly according to an embodiment of the invention which includes a heater 12. Heater 12 partially or fully cures the lithographic precursor material, simultaneously with or subsequent to coating. Heater 12 may comprise any type of electrical heating element. In this case a power supply (not shown) supplies a heating current via a pair of wires 13 to the element when in use. Alternatively, heater 12 may comprise a channel which carries a heated fluid. The fluid may comprise, for example, heated air, heated water or steam. The heat transfer may be through air convection, radiation, induction, or a combination of mechanisms.

The lower portion of chassis 2 near heating element 12 may optionally have fins to enhance convective transfer of heat to a sprayed lithographic precursor material.

### General Operation

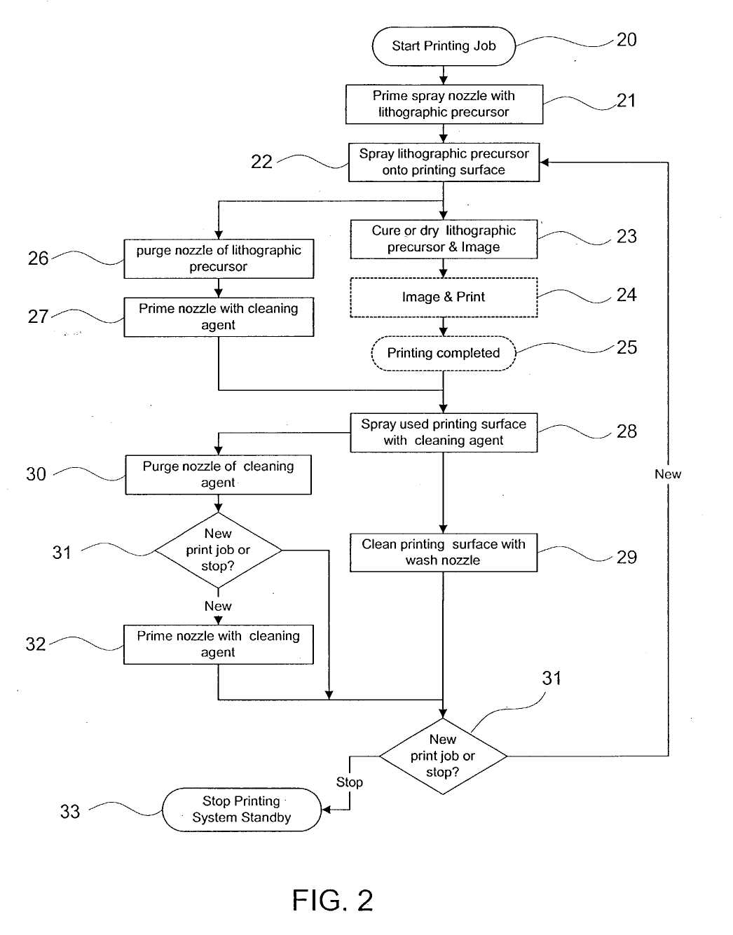

FIG. 2 is a process flow diagram which illustrates a process of operation of a spray nozzle assembly as shown in FIG. 1A or 1B. For convenience the process is described in relation to an on-press system although some of the steps can be performed off-press. The term “on-press” is used herein to describe equipment that is permanently or detachably mounted in proximity to a press cylinder. Likewise, the term “off-press” refers to operations that are performed in equipment separated from a press. For off-press systems, the plate transport is not necessarily a cylinder or drum. Both flatbed and internal drum systems are well known in the art and could be adapted to accommodate the integrated spray nozzle detailed herein. A plate prepared in an off-press system may be manually or automatically transferred to a printing press.

In FIG. 2, steps that are not directly part of the present invention are shown in dashed lines. A new printing job 20 is assumed to start with a cleaned printing substrate ready to receive lithographic precursor material. In step 21, the spray nozzle is primed with a lithographic precursor material. The lithographic precursor material is sprayed onto the printing substrate in step 22. A curing step 23 is followed by a step 24 comprising imaging and printing operations. If a heater 12 is used to partially or fully cure the lithographic precursor then step 23 may be performed simultaneously with step 22. Alternatively, step 23 may be performed separately, prior to imaging step 24.

While steps 23 and 24 are being performed, nozzle 3 is not in use. Purging and priming steps 26 and 27 can be performed in parallel with steps 23 and 24 to save time. Steps 26 and 27 are related to cleaning the nozzle and preparing for cleaning of the printing surface after the printing is finished. In step 26, excess lithographic precursor material is purged from nozzle 3 using a purge fluid. The purge fluid could be air, a gas, water, deionised water, a solvent mixture or any other agent suitable for purging the lithographic precursor material. In step 27, the nozzle is optionally primed with the cleaning agent, which is sprayed onto the used printing surface in step 28 on completion of the printing job 25.

The use of a cleaning agent aids in the removal of printing residue left on the printing cylinder after a printing operation. The term “printing residue” is used herein to describe the materials adhered to the cylinder after completing a print job including but not limited to lithographic precursor material, ink, fountain solution, and any other residual materials deposited on the printing surface in the printing process. Depending on the lithographic precursor material used, a cleaning agent may or may not be required.

Cleaning agents may comprise a fluid or combination of fluids that act to soften or dissolve the ink and lithographic precursor material left on the printing surface following a print job. Advantageously the cleaning agent also coats the inside walls of chamber 7 and dissolves any build-up on the walls from previous spray operations. Build-up of the lithographic material on the walls of shroud 5 or anywhere else in nozzle assembly 1 can interfere with the proper operation of nozzle assembly 1. Therefore it is desirable to effectively remove these products before accumulation occurs.

In washing step 29, waste products are washed off and drawn away by the vacuum from vacuum port 8. Washing step 29 may also clean the nozzle assembly surfaces to prevent build up of materials on those surfaces. Spray nozzle 3 may be purged of cleaning agent in step 30. Steps 29 and 30 may be performed simultaneously. At decision step 31, if no further print jobs are to be run, the nozzles are left in a purged state and the system goes into a standby mode 33 on completion of wash step 29. If another print job is to be run within some chosen time period, spray nozzle 3 is primed in step 32, which may be simultaneous with washing step 29. On completion of steps 32 and 29, the process starts over with the next printing job at step 22.

The above description describes the use of a single nozzle to apply both lithographic precursor material and cleaning agent. Where the integrated spray nozzle is equipped with a wash nozzle 6 for spraying the cleaning agent, priming step 27 may not be necessary. Depending on the lithographic precursor material used and the length of the print job it may, or may not, be possible to do without step 26 as well since the lithographic precursor material may solidify in the nozzle. Regardless, periodic flushing of both nozzles 3 and 6 is expedient, the interval determined by the materials in use and the time between print jobs.

The application of vacuum is implicit in several of the steps of FIG. 2. Vacuum is applied at varying levels in the priming, purging and spraying steps as described more fully below. In general, vacuum may be applied to vacuum port 8 whenever it is desirable to remove excess fluid from chamber 7. Additionally the vacuum can also be left on at a low vacuum flow setting during standby to keep nozzles 3 and 6 dry and to minimize contamination from the printing operation.

The vacuum flow rates required during different steps will depend upon the dimensions and specific details of construction of apparatus according to the invention. In an example embodiment of the invention a flow rate of approximately 5 scfm is maintained during printing to collect overspray, a flow rate of 35 scfm is maintained during washing, a flow rate of approximately 5 scfm is maintained during priming and a flow rate of 1-2 scfm is maintained during standby.

Apparatus according to some embodiments of the invention has several vacuum orifices positioned to effectively remove the residual printing products. In the illustrated embodiments it is advantageous to connect the orifices to a single vacuum port so that the waste products can be collected for later disposal in a safe manner. This simplifies treatment and disposal while enabling the use of a single variable vacuum source for all operations.

The process described above is provided as an example of the operation of the integrated spray nozzle. The order and exact details of the process may be varied depending on the specific circumstances without departing from the invention. Individual components of nozzle assembly 1 will now be discussed in more detail.

### Spray Nozzle

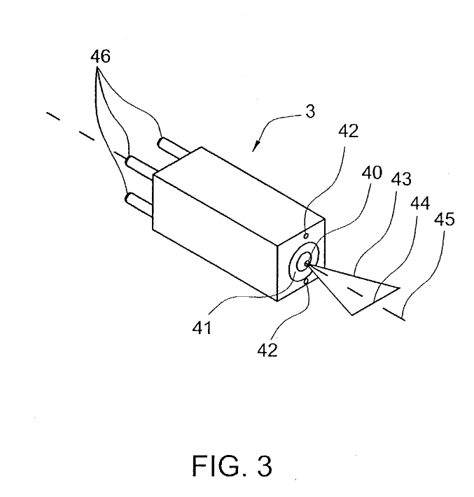

FIG. 3 shows a modular spray nozzle 3. Nozzle 3 can be replaced as a unit if it becomes blocked or requires replacement or servicing. Apparatus 1 may be adapted for different applications by replacing nozzle 3 with another nozzle 3 which provides a different spray profile.

The fluid to be sprayed could be a lithographic precursor material, a nozzle cleaning fluid, or a cleaning agent for removing the lithographic precursor material after use. While the following description relates specifically to a nozzle that uses an airflow to atomize the spray fluid in practice there are many other ways to atomize a fluid for spraying including disk atomizers, piezoelectric or electrostatic atomizers, airless atomizers, air-airless and HVLP (high volume low pressure) atomizers, all of which may be used in the present invention. The type of fluids to be sprayed may also necessitate different choices of spray nozzle, which is facilitated by the modular design of the nozzle of the present invention.

In one embodiment of the invention, nozzle 3 sprays a fluid through a nozzle tip 40. Nozzle tip 40 is surrounded by an air conduit 41. A flow of air or another suitable gas through conduit 41 serves to atomize and direct the lithographic precursor material towards the printing surface. Depending on the lithographic precursor material to be sprayed, air from conduit 41 may optionally be heated to reduce a viscosity of the lithographic precursor material, thus aiding in atomisation. Furthermore, hot air will aid in the curing process to some extent, depending on the materials in use. While air is the most convenient fluid for use as an atomizer other fluids or fluid mixtures, such as clean nitrogen, could also be used.

A plurality of air and fluid connection ports 46 are provided at the rear of modular nozzle 3. One of ports 46 channels fluid to be sprayed through an internal conduit to nozzle tip 40. It is advantageous to include a fast acting shut off valve (not shown) as close to the nozzle tip 40 as possible, particularly if the lithographic precursor material is to be sprayed onto a plate clamped on a cylinder by a clamp. It is undesirable to spray lithographic precursor material over the clamp since the clamp mechanism would become fouled over time and lithographic precursor material would be wasted. The fast acting shut-off valve can be used to interrupt the spray over the clamping area. Where the lithographic substrate is a seamless cylinder, there is typically no need to interrupt the spray but a spray shut off valve close to nozzle tip 40 is still advantageous in enabling precise control over the lithographic precursor material application. The valve could be, for example, a pneumatic solenoid type operated by an air supply via a remote valve (not shown) or a fast acting electrical solenoid valve. The valve element activated by the solenoid typically blocks the fluid passage close to nozzle tip 40.

The shaping of the spray pattern from nozzle 3 is important for both application speed and uniformity. A wide fan spray pattern is particularly advantageous where the lithographic precursor material must not be sprayed over a clamping mechanism since such a pattern can provide a uniform application extending to circumferential edges of a cylindrical printing surface. A fan shaped pattern does not provide such uniform application in the across cylinder direction.

The lithographic precursor material is typically applied while the cylinder rotates. A carriage carrying nozzle assembly 1 is transported along the cylinder in a direction parallel to the cylinder axis. Typically, the carriage advances some fraction of the width of the spray pattern on each revolution of the cylinder, the fraction being optimised to achieve uniform application. A wide fan spray pattern is advantageous for improving application speed by allowing the carriage to be moved faster.

While a fan spray profile is advantageous in some instances, in an embodiment where there is no clamping mechanism to avoid, a simple oval or round spray can also be advantageous, since it will provide better uniformity at the edges. In the circumferential direction, there are no edges to be concerned with since the application in this case is done continuously without a seam or gap.

In one embodiment, an additional pair of air nozzles 42 are located to generate air jets directed towards a point 44 on a central axis 45 of nozzle assembly 3. Air jets from nozzles 42 function in combination with the airflow from conduit 41 to shape the spray emitted by nozzle tip 40 into a fan shape 43. Air nozzles 42 are shown in FIG. 1-A as simple conduits formed in the body of nozzle assembly 3 but they may instead project from the front face of nozzle assembly 3 to further change the desired spray pattern.

Air for conduit 41 and jets 42 may be supplied by way of a remote manifold (not shown). Advantageously air conduit 41 and air jets 42 are supplied separately via separate ports 46 and the flow rates can be individually adjusted at the manifold to achieve the desired spray pattern. In this embodiment, if air jets 42 are not used, the resulting spray pattern is either circular or oval. Clearly other methods of shaping the spray pattern can be used, the most common being the shaping of the nozzle tip 40 to produce the desired spray profile. While this approach is commonly used in commercial spray applications, such as aerosol paint cans, the situation in lithographic precursor material application is more constrained, as the atomisation must take place in a very short distance. In commercial spray applications, it is possible to allow atomisation to occur over 15 cm to 25 cm, while in the present invention this distance is typically an order of magnitude less.

FIG. 1-A shows place for a second spray nozzle 4 alongside spray nozzle 3 on chassis 2. Additional nozzle 4 is optionally included to separate the lithographic precursor material spraying function from the spraying of other fluids such as a cleaning solution. Additional nozzle 4 could also be used to apply one part of a lithographic precursor material that comprises two reactants that should be sprayed from separate nozzles. In the preferred embodiment, a single nozzle is used to spray all fluids, thus reducing the overall cost of the assembly. Configurations involving two or more nozzles also come within the invention.

### Overspray Containment and Collection

Imperfect containment of the spray pattern and bounce-back from the printing surface can result in mist and fumes that do not adhere to the printing substrate. If this overspray is not effectively removed, it will tend to foul surfaces of the nozzle(s) and may escape into the surrounding environment. The fumes may present a health hazard. Vacuum port 8 (see FIG. 1-A) is connected to a source of vacuum to draw overspray out of the spray area. The flow into vacuum port 8 should be sufficient to collect the overspray without producing excessive turbulence which would interfere with the uniform application of the lithographic precursor material to the printing surface. Advantageously the surfaces of chamber 7 are profiled to ensure that the vacuum flow does not directly interfere with the spray transfer.

It is advantageous to make shroud 5 removable, for example, by slidably attaching it to chassis 2. Shroud 5 is particularly prone to build-up of lithographic precursor material. It is convenient to make shroud 5 easily removable for cleaning and/or replacement. In the embodiment shown in FIG. 1-B shroud 5 is attached to chassis 2 via sliding mechanism 14. A reasonable seal should be provided between shroud 5 and chassis 2. Shroud 5 could attach to chassis 2 in other ways, for example, by way of a dovetail groove, any other sliding attachment method known in the art, or the like. Additionally, screws or pins could be provided to ensure that shroud 5 stays in place during operation of assembly 1.

### Spray Nozzle Purging and Priming

There is a need to purge the nozzle(s) of assembly 1 from time to time to avoid lithographic precursor material solidifying and blocking the nozzle conduits. Certain materials may also tend to corrode the nozzle conduit if not purged. Furthermore, when it is required to change the nozzle supply from, for example, a lithographic precursor material to a cleaning agent, the nozzle needs to be primed with the new fluid after purging.

Purging may involve switching on the vacuum source connected to vacuum port 8 and the fluid flow shutter (see below); switching to supply a purge material to the nozzle(s) to be purged; running the purge material through the nozzle(s) for sufficient time to clean the nozzle(s); and, optionally, running air (or another gas) through the nozzle(s) to expel the purging material. The purging material may comprise water, alcohol or another universal solvent or a cleaning material selected to purge a particular precursor material from a nozzle.

Priming may involve switching on the vacuum source connected to vacuum port 8 and the fluid flow shutter; connecting the nozzle to a supply of fluid to be sprayed; and expelling fluid from the nozzle for sufficient time to carry any air bubbles out of the nozzle.

During purging or priming, the nozzle must be able to vent freely, but since it cannot be allowed to vent onto the printing substrate provision needs to be made to contain the priming and purge products.

A novel solution is to make use of an additional jet fed from a port 9 (see FIG. 1-A) to create a fluid flow shutter in front of the nozzle(s). The fluid flow shroud effectively closes off chamber 7 from the outside environment. The fluid ejected from port 9 to generate the fluid flow shroud may comprise air, water, or any other convenient fluid. Advantageously the flow of fluid ejected from port 9 is profiled to provide effective containment of materials vented from one or more nozzles. A suitable valve controls fluid flow to port 9 so that the fluid flow shutter can be turned on or off.

In simple embodiments of the invention, port 9 channels air from an orifice in the top part of shroud 5 transversely in front of nozzles 3 and 4. The orifice may comprise a round hole. Other orifice shapes may also be used. Where apparatus 1 comprises more than one spray nozzle, a separate orifice may be provided to direct a flow of fluid from port 9 past each of the nozzles. In the alternative, port 9 may be connected to an elongated orifice that provides a fluid flow shroud extending across more than one of the nozzles. Other configurations of orifices may also be used to provide a fluid flow shroud in front of the nozzle(s) of apparatus 1. It is not necessary that all of the orifices be directed in the same direction.

With a vacuum applied to vacuum port 8 and air from port 9 channelled through one or more nozzles directed across the opening of chamber 7, purge or priming waste is contained within chamber 7 and drawn away by vacuum port 8.

Typically, the vacuum is set to a low level for this operation since the flow volume of purge product is small. High vacuum levels may create turbulence and defeat the action of the fluid flow shutter.

As an alternative to a fluid flow shutter, or to augment the effect of a fluid flow shutter, a mechanical shutter can be provided to partially or fully close off chamber 7 during purging or priming. A mechanical shutter could be actuated to cover the opening by electrical, hydraulic, or pneumatic means. The mechanical shutter may comprise a blade coupled to an actuator capable of moving the blade into a position which substantially blocks the opening of chamber 7.

### Wash Nozzle

For successful printing, the printing surface bearing imaged lithographic precursor material, should be durable enough to withstand the wear of the printing operation. While some lithographic precursor materials used in direct-to-press systems are less sensitive to residuals left after cleaning than others it is generally important to substantially remove the used lithographic precursor material, ink, and other materials before starting a new print job to prevent build-up over time. As already described, spray nozzle 3 can optionally be used to apply a cleaning agent onto a used printing surface to aid in cleaning the printing surface. After printing the printing surface will carry a mixture or inks, fountain solution, imaged lithographic material and other debris or printing products. The next step in the process is to wash the printing surface to release these products, optionally softened by the application of a cleaning agent. Simultaneous with this, the removed products must be effectively drawn away from the substrate so that they do not foul the press and imaging system.

In certain embodiments of this invention cleaning is achieved by directing fluid from a wash nozzle onto the printing surface to lift the used printing products and direct them away from the printing substrate in combination with a vacuum source to draw the products away. The wash fluid is supplied via a commercial pressure wash or similar device capable of delivering high-pressure fluid at a reasonable flow rate. The wash fluid may be delivered at pressures in the range of less than 100 psi to several thousand psi. Pressures of a few hundred psi are typically sufficient. In an example embodiment of the invention wash fluid is delivered at a pressure of about 500 psi.

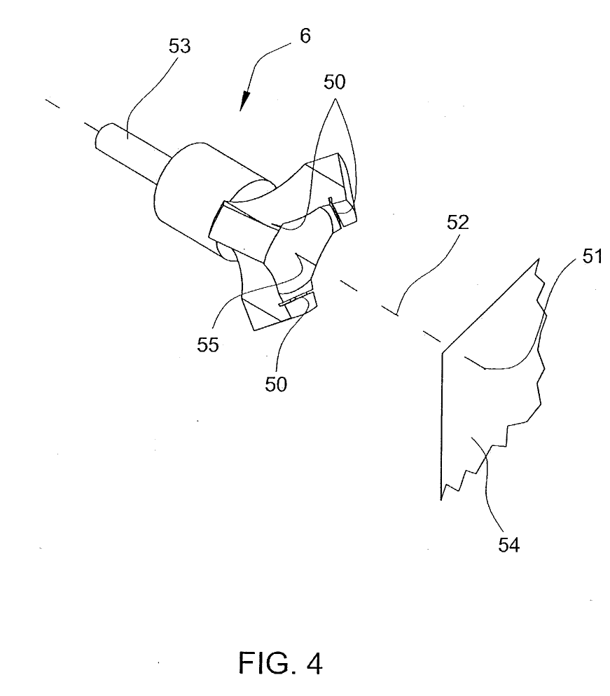

In an embodiment of the invention shown in FIG. 4, a wash nozzle 6 has three jets 50, angled and circumferentially spaced so that they point inwards towards a central point 51 on an axis 52. Wash fluid at relatively high pressure is channelled through a conduit 53 to jets 50. The wash fluid provides energy to lift and release the waste products from the printing surface and direct them towards the vacuum port. Water is most convenient for use as a wash fluid although other agents could be added to improve the cleaning efficiency in specific cases. The flow momentum of the wash jets in a direction toward axis 52 will substantially cancel out. After hitting the printing surface the wash fluid flows in a jet directed from printing surface 54 back toward wash nozzle 6 along axis 52.

In an example embodiment of the invention, wash nozzle 6 has three jets 50 equally spaced around the circumference of a 25 mm diameter circle. The jets are each spaced approximately 10 mm away from a printing surface. The jets are angled inwardly at an angle of approximately 45 degrees to a line normal to the printing surface and passing through the centre of the circle.

Printing surface 54 is typically located at or near point 51 and may be substantially perpendicular to axis 52 or at an angle thereto. Flow components outwards along the printing surface are minimized, thus containing most of the lithographic precursor material and ink waste in the redirected jet.

By causing the flow from multiple jets 50 to impinge against each other on printing surface 54, turbulence in the wash fluid at printing surface 54 is increased, resulting in improved cleaning. The converging flow pattern results in a more definite wash swath on the printing surface than a single jet enabling more effective washing adjacent to the edges of the plate.

In an alternative embodiment, wash nozzle 6 is arranged to rotate about axis 52 at some angular velocity further increasing the wash jet turbulence at the printing surface. The rotation actuation may be provided by the flow of the wash fluid through wash nozzle 6 or by some other means.

While the embodiment shown in FIG. 4 has three converging jets, the number of jets can be increased to improve cleaning and collection efficiency. Adding a fourth and subsequent jets has a more marginal impact on performance than the addition of the third jet. Using three or more jets provides a significant containment advantage over a single jet or and even a pair of converging jets. A single jet of wash fluid tends to allow lithographic precursor material products to escape along the periphery of the spray.

Advantageously jets 50 each have a slot-shaped orifice to create a jet having a flattened profile. Jets 50 may be similar in configuration to the jets used in commercial pressure washing devices. With this configuration, each jet 50 produces a narrow line of spray at the printing surface. Other jet profiles could also be used. The point of convergence 51 of jets 50 is not necessarily located precisely at the printing surface. The adjustment of the impingement of the jets can be empirically determined through tests to determine the optimal setting, the trade-off being between washing area and containment.

Wash fluid flow is channelled through a port (not shown) on the back of chassis 2 (see FIG. 1-A) and is controlled by a valve 10, which could be a fast acting valve. While it is not usually essential, valve 10 may be capable of interrupting the flow of wash fluid when wash nozzle 6 is passing over the clamping area of a printing cylinder. Wash fluid may be supplied from a commercially available pressure washer unit sized according to the requirements for the lithographic precursor material used. A vacuum port 8, or plurality of vacuum ports, are provided behind wash nozzle 6, establishing a vacuum flow past wash nozzle 6 in the same general direction as the redirected jet.

Used products directed back towards the centre of wash nozzle 6 along axis 52 (see FIG. 4), will generally strike a central area 55 of wash nozzle 6. Advantageously wash nozzle 6 is profiled to enhance the transfer of wash effluent to vacuum port(s) 8. In the embodiment shown in FIG. 4, the sides of wash nozzle 6 are scalloped to provide preferential paths for wash effluent carrying the lithographic precursor material products to be evacuated. The orifices of wash nozzle 6 may be located around a perimeter of vacuum port 8.

As mentioned previously it is advantageous to minimise the possibility of the lithographic materials building up on surfaces of nozzle assembly 1. In an embodiment of the present invention, one or more additional wash jets can be directed towards the walls of chamber 7 to actively clean these surfaces during the wash cycle.

The tips of wash nozzle 6 are prone to wear due to the high-pressure fluid passing through them. It is advantageous to make these nozzles from a hard material such as stainless steel for best service life.

### Recycling and Recovery of Waste Products

In a cleaning operation, fairly large volumes of wash fluid together with the various printing residues are collected via vacuum port 8. Even if the wash fluid is substantially aqueous and benign, in an ever more environmentally conscious world, the small amounts of other agents included in the waste may prohibit its disposal without further treatment.

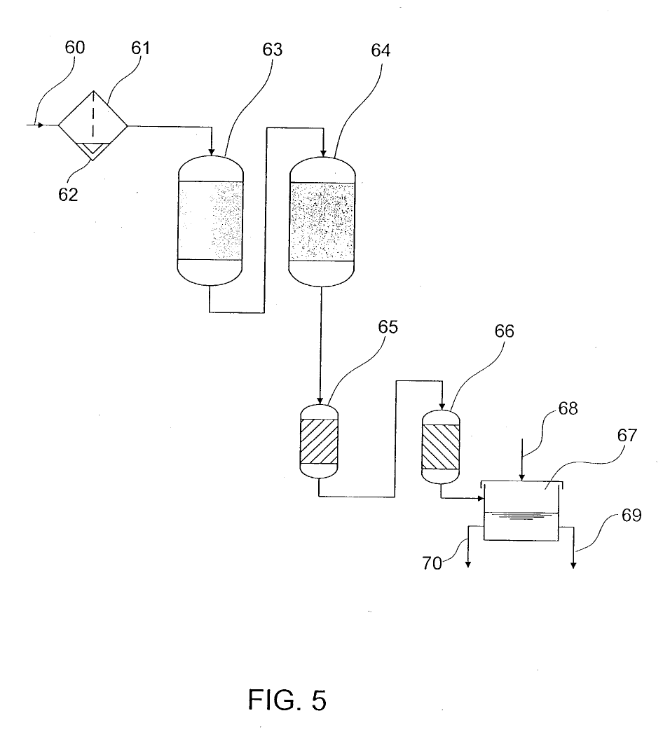

A system may be incorporated to allow treatment and recycling of the wash fluids. An example embodiment of a waste treatment system for a direct-to-press imaging system is shown in FIG. 5. Wash effluent from one or more vacuum ports of an integrated spray nozzle enters the treatment system via fluid line 60. The wash effluent typically comprises wash fluid, lithographic precursor material, ink, and cleaning agent along with traces of the purge solutions and the press fountain solution. Paper dust and other solid debris may also be collected. Depending on the inks and other materials used in the process the wash effluent may contain oil-based substances that are immiscible in water.

In a first stage, separator 61 separates ink products 62, which are substantially immiscible in water, from the effluent delivered by fluid line 60. Separator 61 could comprise a hydrocyclone, a centrifugal separator, or a skimmer or any other separator known in the art. Separator 61 is followed by a pair of filters 63 and 64 which remove particulates from the wash effluent. A vacuum source maybe connected between separator 61 and filters 63. Filter 64 has a finer matrix than filter 63. While two filters are shown, any number of filtration stages or even a single filter can be used, the choice depending on the materials present in the wash fluid. The particulate filters are selected to remove a substantial portion of the suspended solids and remaining ink solids from the wash effluent.

In a second filtration stage, effluent from filter 64 is passed to one or more chemical filters. The chemical filters remove a substantial portion of any chemical agents present in the wash effluent. The chemical filters could be of the activated carbon type or peat or any other chemical filter composition known in the art. In the present embodiment two chemical filters 65 and 66 are shown but it should be apparent that the number and type of the chemical filters will be determined for a particular choice of direct-to-press imaging materials and printing inks expected to be present in the wash effluent.

Treated effluent from chemical filter 66 is channelled into a holding tank 67. If the treated wash effluent is to be reused for further washing operations the holding tank may serve as a reservoir for the wash system intake. Make up water may be added to holding tank 67 via line 68 which can be controlled via automatic means to maintain a prescribed fluid level in holding tank 67. Alternatively, make up wash fluid can be added at the pressure washer pump or other convenient point. Recycled wash fluid is drawn from holding tank 67 via fluid line 69 for subsequent washing operations.

Alternatively, if the wash fluid is not reused the effluent from chemical filter 66 is passed to the sewer or other wastewater collection system, either directly or from holding tank 67 via a drain 70.

Filters 63, 64, 65, and 66 may all be of the replaceable cartridge type and may include sensors and monitoring capability to indicate to the operator when a filter element should be cleaned or replaced.

Where an on-site platemeking system comprises several independent or linked units, as would be the case for a multi-color press, wash effluent from all of the units may be channelled to a common treatment system. This provides a significant cost saving and convenience over separate systems for each individual system.

To permit recycling of the wash fluid, the residual level of waste material in the treated wash effluent must be kept below a maximum tolerable level which will depend on the lithographic precursor material, inks and other solvents in use. For some lithographic precursor materials, even trace amounts of cleaning agent or other contaminants will preclude proper adhesion to the printing surface. The recycling system is tailored to meet the requirements set by the lithographic precursor material used as well as inks, cleaning agent, purge solution etc.

There have thus been outlined the important features of the invention in order that it may be better understood, and in order that the present contribution to the art may be better appreciated. Those skilled in the art will appreciate that the conception on which this disclosure is based may readily be utilized as a basis for the design of other apparatus for carrying out the several purposes of the invention. It is most important, therefore, that this disclosure be regarded as including such equivalent apparatus as do not depart from the spirit and scope of the invention.

We claim:

1. An apparatus for applying an imageable coating to a substrate, the apparatus comprising:
at least one spray nozzle directed toward the substrate, the nozzle connectable to a supply of an imageable coating material; and,
at least one wash nozzle directed at the substrate the wash nozzle connectable to a source of pressurised wash fluid;
wherein the spray nozzle and the wash nozzle form an integrated unit.

2. An apparatus according to claim 1 adapted for preparing and recycling a printing surface wherein the imageable coating material comprises a lithographic precursor material and the substrate comprises a printing surface.

3. An apparatus according to claim 2 comprising a source of a cleaning agent and a switch for connecting the nozzle to the source of the cleaning agent to aid in cleaning printing residues from the printing surface following a printing operation.

4. An apparatus according to claim 1 comprising a shroud defining a chamber surrounding the spray nozzle and the wash nozzle and extending toward the substrate and a vacuum port connected to withdraw fluid from the chamber.

5. An apparatus according to claim 4 wherein the shroud is removeably attached to the integrated unit.

6. An apparatus according to claim 4 comprising a moveable shutter movable to a position wherein the shutter is interposed between the spray nozzle and the substrate by a shutter actuator.

7. An apparatus according to claim 4 wherein the vacuum source is controllable to provide an adjustable flow rate through the vacuum port, and the apparatus comprises a controller configured to control the vacuum source.

8. An apparatus according to claim 4 wherein the integrated unit comprises a heater located to heat the imageable material on the substrate.

9. An apparatus according to claim 4 wherein the substrate comprises one of a metal plate and a polyester plate.

10. An apparatus according to claim 9 wherein the substrate comprises an aluminium plate.

11. An apparatus according to claim 2 wherein the substrate comprises a printing surface of the printing cylinder and the integrated unit is mounted adjacent to the printing cylinder.

12. An apparatus according to claim 2 comprising at least one shutter jet disposed to direct a stream of fluid transversely in front of the spray nozzle to provide a fluid flow shutter operative to contain purging and priming products ejected by the spray nozzle.

13. An apparatus according to claim 4 comprising one or more wash jets disposed to clean inside surfaces of the shroud.

14. An apparatus according to claim 2 wherein the spray nozzle comprises an atomizer selected from the group consisting of: disk atomizers, piezoelectric atomizers; electrostatic atomizers; and air atomizers.

15. An apparatus according to claim 2 wherein the spray nozzle comprises an air atomizer and a source of heated air connected to supply air to the air atomizer.

16. An apparatus according to claim 1 wherein the wash nozzle comprises two or more orifices connectable to the source of pressurized wash fluid, the jets disposed to direct converging jets of the wash fluid at the substrate.

17. An apparatus according to claim 16 comprising a valve connected to control a flow of the wash fluid through the orifices.

18. An apparatus according to claim 16 wherein the orifices have elongated slit shapes.

19. An apparatus according to claim 1 wherein the at least one wash nozzle comprises a plurality of orifices spaced apart from one another around a central axis and oriented symmetrically relative to the axis to generate converging jets of wash fluid directed at the substrate.

20. An apparatus according to claim 19 wherein the orifices have elongated slit shapes.

21. An apparatus according to claim 19 wherein the at least one wash nozzle is configured to rotate while delivering the wash fluid through the orifices.

22. An apparatus for preparing and recycling a printing surface, the apparatus comprising:
a support chassis;
at least one spray nozzle for coating a printing substrate with a lithographic precursor material and for optionally applying a cleaning agent to aid in cleaning printing residues from the printing surface following a printing operation;
at least one wash nozzle, supplied with a source of pressurised wash fluid, the wash nozzle directed at the printing surface for removing the printing residues therefrom;
a shutter jet disposed to eject a fluid stream across in front of the spray nozzle during a purging or priming operation, the fluid stream operative to contain purging and priming products ejected by the spray nozzle; and,
a shroud surrounding the spray nozzle and the wash nozzle and extending towards the printing substrate, the shroud operative in combination with at least one orifice connected to a vacuum source to remove overspray and residues generated in the operation of the spray nozzle and the wash nozzle.

23. A spray nozzle apparatus for coating a substrate with an imageable fluid the apparatus comprising:
a nozzle body having a plurality of fluid connection ports on a rear side thereof;
a spray nozzle tip on a front side of the nozzle body for ejecting the imageable fluid, the spray nozzle tip connected to one of the connection ports via a fluid conduit extending through the nozzle body; and,
a conduit surrounding the spray nozzle tip, the conduit connectable via another one of the fluid connection ports to a supply of pressurized atomising fluid.

24. A spray nozzle apparatus according to claim 23 detachably mounted to coat a printing plate with the imageable fluid in an on-site lithographic platemaking system.

25. An apparatus according to claim 23 wherein the connection ports comprise quick connect fittings.

26. An apparatus according to claim 23 comprising a shut-off valve located in the fluid conduit close to the nozzle tip for interrupting the spray of the imageable fluid.

27. An apparatus according to claim 28 wherein the shut-off valve is a pneumatically controlled valve comprising a control port connected to one of the connection ports.

28. An apparatus according to claim 23 comprising one or more air nozzles disposed to generate air jets which interact with a stream of fluid from the nozzle tip and shape the spray to have a desired spray profile.

29. An apparatus according to claim 28 wherein the desired spray profile is fan shaped.

30. An apparatus according to claim 28 wherein the air nozzles protrude from the front of the nozzle body.

31. A method for coating a printing substrate with a fluid in an on-site platemaking system, the method comprising:
providing a source of fluid;
ejecting the fluid via a spray nozzle tip; and,
atomizing the fluid and directing the atomized fluid towards the printing substrate using a flow of pressurised fluid through an air conduit surrounding the spray nozzle tip.

32. A method for recovering a wash fluid from a wash effluent containing residues from washing a printing surface after use in a printing operation, the method comprising:
collecting the wash effluent via one or more orifices, the orifices coupled to a vacuum source; and,
reusing the wash effluent as wash fluid in a subsequent cleaning operation.

33. A method according to claim 32 comprising separating the residues from the wash effluent in one or more fluid treatment stages prior to the reuse.

34. A method according to claim 33 comprising adding clean water to the wash effluent prior to the reuse.

35. A method according to claim 33 wherein the fluid treatment stages comprise adding a substance to the separated printing residues to neutralize the separated printing residues.

36. A method according to claim 33 wherein the fluid treatment stages comprise removing the printing residues by filtration.

37. A method according to claim 36 wherein the filtration comprises at least one particle filtration stage.

38. A method according to claim 36 wherein the filtration comprises at least one chemical filtration stage.

39. A method according to claim 38 wherein the chemical filtration removes immiscible substances contained in the wash effluent.

40. A method according to claim 33 wherein the fluid treatment stages comprise a separation stage.

41. A method according to claim 40 wherein the separation stage comprises passing the wash effluent through at least one of a hydrocyclone, a skimmer and a centrifugal separator.

42. A method according to claim 33 comprising collecting wash effluent from a plurality of on-site lithographic platemaking systems and performing the fluid treatment on the collected wash effluent in a single treatment system.

43. A wash nozzle system for removing residues from a printing surface following a printing operation, the wash nozzle comprising two or more wash fluid orifices connected to a source of pressurized wash fluid, the wash fluid orifices disposed to direct converging jets of the wash fluid at the printing surface.

44. A wash nozzle system according to claim 43 wherein the two or more jets have their respective flows directed to at least partially converge at a point near the printing surface such that printing residues released from the printing surface are re-directed away from the printing surface.

45. A wash nozzle system according to claim 44 comprising a vacuum orifice connected to a vacuum source, the vacuum orifice disposed to collect the redirected printing residues.

46. A wash nozzle system according to claim 45 wherein the jets are arranged around a periphery of the vacuum orifice.

47. A wash nozzle system according to claim 58 wherein the wash fluid orifices are housed on a common body for holding the wash fluid orifices in fixed locations relative to one another.

48. A wash nozzle system according to claim 47 wherein the common body is shaped to cause the redirected printing residues to flow into one or more vacuum orifices connected to a vacuum source.

49. A wash nozzle system according to claim 47 comprising at least three wash fluid orifices arranged in an annular formation.

50. A wash nozzle system according to claim 49 wherein the wash fluid orifices are elongated so that the jets are substantially fan shaped.

51. A wash nozzle system according to claim 44 wherein the jets are directed to converge at a point beyond the surface of the printing medium.

52. A wash nozzle system according to claim 47 wherein the common body is disposed to rotate during a washing operation.

53. A wash nozzle system according to claim 52 wherein the common body is configured to be driven in rotation by a flow of wash fluid through the wash fluid orifices.

54. A method of removing printing residues from a printing surface following a printing operation, the method comprising:
directing two or more jets of a wash fluid at the printing surface to release the printing residues from the printing surface;
redirecting the printing residues away from the printing surface; and,
collecting the printing residues using a vacuum source.

55. A method according to claim 54 wherein the two or more jets of wash fluid converge toward an axis.

56. A method according to claim 55 comprising rotating the two or more jets of wash fluid about the axis.
